(19) United States
(12) Patent Application Publication
(10) Pub. No.: US 2012/0215396 A1
(43) Pub. Date: Aug. 23, 2012

(54) SYSTEM AND METHOD FOR EMULATING VEHICLE IGNITION-SWITCHED POWER

(76) Inventors: Brennan Todd Hamilton, Birmingham, MI (US); Michael D. Valentine, Cincinnati, OH (US)

(21) Appl. No.: 13/401,278

(22) Filed: Feb. 21, 2012

Related U.S. Application Data
(63) Continuation of application No. 12/261,792, filed on Oct. 30, 2008, now abandoned.
(60) Provisional application No. 61/083,265, filed on Jul. 24, 2008.

(51) Int. Cl. G06F 7/00

(52) U.S. Cl. 701/29.1

(57) ABSTRACT

A power supply configured to emulate the functionality of ignition-switched power in a vehicle is configured to plug into an on-board diagnostics port (OBD-II) in the vehicle. The power supply includes a controller that is configured to determine the operating protocol to use and then communicates queries based on the determined protocol to obtain the current values for the engine speed and vehicle speed. The controller compares the current values against predetermined thresholds to determine whether the vehicle operating state is in an ignition-on state. When in the ignition-on state, the controller asserts an enable control signal, which is provided to a switch that responds by switching the un-switched vehicle battery from the OBD-II port to an output interface of the power supply. When the controller determines that the vehicle is no longer in an ignition-on state, the controller de-asserts the enable control signal, thereby removing the power from the output interface.

### CROSS-REFERENCE TO RELATED APPLICATIONS

This application is a continuation of U.S. application Ser. No. 12/261,792 filed Oct. 30, 2008, now pending, which claims the priority benefit of U.S. Provisional Application No. 61/083,265 filed Jul. 24, 2008, the disclosure of each application of which are hereby incorporated herein by reference in their entireties.

### BACKGROUND OF THE INVENTION

1. Technical Field

The present invention relates generally to power supply systems and more particularly to a system and method that emulates the functionality of vehicle ignition-switched power in a vehicle.

2. Description of the Related Art

Power for operating in-vehicle accessories, such as radar detectors, global positioning systems (GPS) navigation systems, cellular telephones, personal computers and the like have conventionally been provided through two mechanisms. The first mechanism involves the use of the well-known cigarette lighter plug. Many accessories are provided with a plug adapter that fits directly into the cigarette lighter. However, some of the cigarette lighter plug arrangements are un-switched, meaning that the vehicle battery is unprotected against undesirable battery drain arising from electrical load that the accessory presents. The second known mechanism involves hard-wiring the power lead directly into the electrical system of the vehicle. However, most consumers lack the necessary experience or tools needed to hard-wire an accessory device into their vehicle. Such an approach typically involves locating a suitable power circuit that is either (i) ignition switched (i.e., to protect the vehicle battery from undesirable drain, as noted above); or alternatively (ii) un-switched, again meaning that such circuit is hot (or live) regardless of the state of the vehicle ignition. Finally, once a power circuit is found, the accessory device would have to be connected. In this regard, most consumers are interested in maintaining the aesthetics of their vehicle interior as well as maintaining the ability to quickly disconnect (and re-connect as needed) the accessory device. Hard wire approaches may impair one or both of these considerations.

Known in-vehicle powering approaches have not been entirely satisfactory, particularly for general powering use for a wide variety of accessory devices. For example, it is known to access an in-vehicle diagnostic port to obtain power, as seen by reference to U.S. Patent Publication 2008/0122288 A1 entitled “POWER MANAGEMENT SYSTEMS FOR AUTOMOTIVE VIDEO EVENT RECORDERS” to Plante et al. Plante et al. disclose a powering approach for a specific device, namely, a video event recorder for police cruiser type patrol vehicles. Plante et al. disclose a power management module that is coupled to a vehicle power source via an on-board diagnostic system (i.e., a standard OBD-II type “D” connector). Plante et al. further disclose a detection mechanism that determines the use state of the vehicle and adjusts the application of power accordingly and which in one version calls for detecting the presence of a prescribed type of data traffic on the data bus as monitored via the OBD-II connector. However, Plante et al. do not describe what is meant by prescribed type of traffic and in any event from the examples therein “in-use” does not appear wholly co-extensive with the ignition-on or ignition-off states. Additionally, certain accessory devices require a greater amount of power that can be directly provided by way of the OBD-II port. Plante et al. does not provide for an external trigger or like mechanism to activate an external power supply or any other means to accommodate this situation. Finally, Plante et al. do not appear to contemplate a power connection of general applicability.

There is therefore a need to provide a system and method for providing ignition-switched power to vehicle accessories that minimizes or eliminates one or more problems described above.

### SUMMARY OF THE INVENTION

The invention provides a system and method that emulates the functionality of ignition-switched power in a vehicle. One advantage of the present invention is that it protects the vehicle battery from undesirable accessory battery drain. In addition, the invention, in certain embodiments, includes standardized connectors which allow it to be easily installed to the vehicle as well as to the accessory. Finally, embodiments of the invention may be used in nearly any 1996 model year (or later) OBD-II compliant vehicle.

A power supply for use in a vehicle includes a vehicle interface and a controller. The vehicle interface is configured for connection to a vehicle diagnostic port, which in one embodiment may be an on-board diagnostic (OBD-II) compliant diagnostic port. The diagnostic port is configured to provide access to a vehicle network, which allows retrieval of stored diagnostic and vehicle operating data. The diagnostic port also provides un-switched vehicle power. The controller, which in one embodiment may be a programmed microcontroller, is configured to communicate via the vehicle interface through the vehicle diagnostic port to obtain current values for an engine speed parameter and a vehicle speed parameter. The controller is further configured to assert an enable control signal indicative of the operating state of the vehicle (“ignition-on state”) based on at least the engine speed and vehicle speed parameters.

As described above, the vehicle interface of the power supply is configured to receive a power signal (e.g., un-switched vehicle battery power) from the diagnostics port (e.g., OBD-II port) itself. The controller is further configured to determine whether to assert the enable control signal further as a function of the level of the power signal (e.g., assert the enable signal provided the power signal V_{BATT} also meets or exceeds a predetermined minimum level).

The enable signal may be used as a trigger signal that can be provided to an external, trigger-operated power supply. In a preferred embodiment, the power supply further includes a switch configured to selectively switch or transfer the power signal from the diagnostic port to an output interface of the power supply based on whether the enable signal is asserted or not. This essentially emulates ignition-switched power as it goes on and off based on the operating (ignition) state of the vehicle. The output interface may comprise, in one embodiment, a standardized connector, such as an RJ-11 jack, to facilitate easy and rapid connection and disconnection of accessories to the inventive power supply.

A method is also presented for operating a power supply that is configured to emulate the functionality of ignition-switched power in a vehicle.

### BRIEF DESCRIPTION OF THE DRAWINGS

The present invention will now be described by way of example, with reference to the accompanying drawings:

FIG. 1 is a simplified, perspective view showing an embodiment of the inventive power supply in an exemplary, passenger vehicle environment.

FIG. 2 is a schematic and block diagram of the power supply of FIG. 1.

FIG. 3 is a flowchart diagram showing a method for operating the power supply of FIG. 1.

### DETAILED DESCRIPTION OF THE PREFERRED EMBODIMENTS

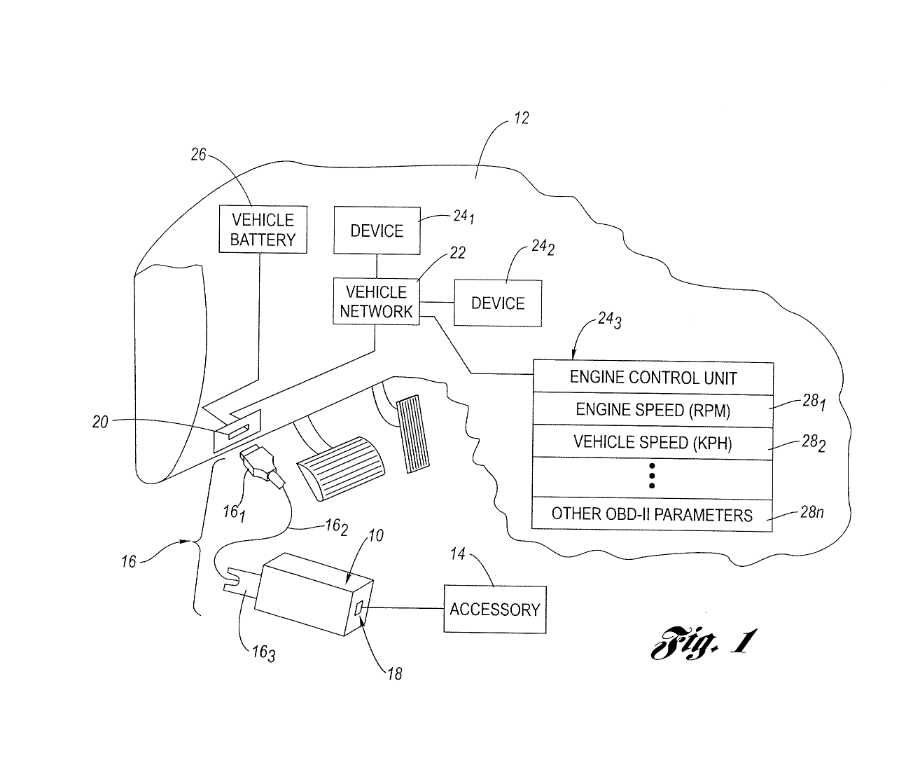

Referring now to the drawings wherein like reference numerals are used to identify identical components in the various views, FIG. 1 is a perspective view of a power supply 10 configured to emulate the functionality of ignition-switched power in a vehicle 12, an interior cabin portion of which is shown—partially broken away. The power supply 10 is operative to selectively provide power to an attached accessory 14 based on an operating state of the vehicle (i.e., an ignition-on state or an ignition-off state). Embodiments of the inventive power supply 10 allow it to be simply plugged into a vehicle diagnostics port (e.g., an OBD-II port; more on this below) to provide power to the accessory 14 that switches on and off to emulate an ignition-switched hard-wired connection. No tools or special connections are necessary. Installation is as simple as locating the vehicle diagnostics port and plugging in the power supply 10. Through the foregoing functionality, the accessory 14 can be powered through the power supply 10 without the risk of undesired drainage of the vehicle battery.

As show in FIG. 1, the power supply 10 includes a vehicle interface 16 and an output (accessory) interface 18. The vehicle interface 16 is configured to effect mechanical and electrical connections to the vehicle 12 by way of a vehicle diagnostics port 20. The vehicle diagnostics port 20 is configured to provide access to a vehicle communications network 22 to which one or more electronic devices 24₁, 24₂, 24₃ may be connected. Through this OBD-II diagnostic port 20, access may be made directly to the vehicle's diagnostic and operating data stored therein (e.g., in the ECU—described below).

In one embodiment, the vehicle diagnostics port 20 comprises an on-board diagnostic (OBD-II) connector/interface, which is preferably a Society of Automotive Engineers (SAE) J1962 standard OBD-II diagnostic connector. This connector may be a female-type having (16) electrical connections, as known. Significantly, the presence of the OBD-II connector is mandated (i.e., by the Environmental Protection Agency) on all cars and light trucks built since the 1996 model year, thereby assuring broad applicability of embodiments of the invention. In many instances, the diagnostics port 20 may be located underneath the vehicle's instrument panel below the steering column, in the cabin's interior. While the diagnostics port 20 is ostensibly provided to allow for the connection of service tools and the like, the diagnostics connector 20 also provides, as described above, a connection suitable for communications with various vehicle network devices, such as a powertrain controller or the like (e.g., the engine control unit (ECU) 24₃ of FIG. 1). Un-switched vehicle power (V_{BATT}) from a vehicle battery 26 is also provided on the diagnostics port 20. As known, V_{BATT} may be a direct current (DC) voltage, typically around 12V when the engine is not running, and may be slightly greater than 14 volts when the engine is running (and thus while the vehicle generator is in operation). Table 1 below provides the pin-out description for the vehicle diagnostics port 20, in a preferred embodiment.

TABLE 1
OBD-II (SAE J1962) Pin Description

| J1962 Pin | J1962 Pin Description |
|---|---|
| 1 | Discretionary* (GMLAN SW CAN Line) |
| 2 | + line of SAE J1850 |
| 3 | Discretionary* (GMLAN MS CAN H) |
| 4 | Chasses Ground |
| 5 | Signal Ground |
| 6 | CAN H |
| 7 | K Line of ISO 9141-2 |
| 8 | Discretionary* |
| 9 | Discretionary* (GM ALDL) |
| 10 | − line of SAE J1850 |
| 11 | Discretionary* (GMLAN MS CAN L) |
| 12 | Discretionary* |
| 13 | Discretionary* |
| 14 | CAN L |
| 15 | L line of ISO 9141-2 |
| 16 | Un-switched Vehicle Battery Positive (V_{BATT}) |

Where “Discretionary* means that the SAE J1962 specification leaves this pin for use at the discretion of the manufacturer.

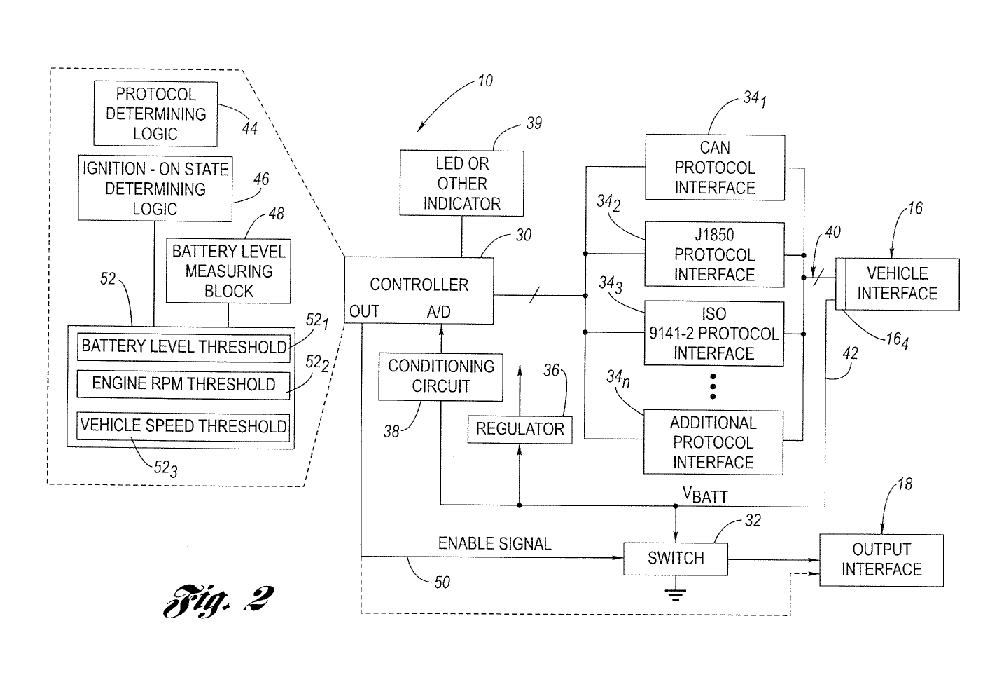

With continued reference to FIG. 1, the vehicle interface 16, in a constructed embodiment, may include a standardized male type SAE J1962 connector designated 16₁ in FIG. 1 configured to mate with the standardized female-type OBD-II diagnostics port 20, a desired length of connecting cable designated 16₂ and a standardized DB-9 female-type connector designated 16₃ to mate with a corresponding DB-9 male connector designated 16₄ (best shown in FIG. 2) included on a printed circuit board of the power supply 10. It should be understood that this configuration is exemplary only and not limiting in nature. The art is replete with alternate connection arrangements, as known.

The output interface 18 may comprise a standardized connector for simplicity of disconnection and re-connection of the power supply 10 output to the accessory 14. In a constructed embodiment, the output interface may be a registered jack (RJ), such as an RJ-11 jack (e.g., pin 3 being the ignition-switched emulated V_{BATT} output and pin 4 being ground). Other variations, of course, are possible.

The invention emulates ignition-switched power through the process of determining the operating state (i.e., ignition-on state or ignition-off state) of the vehicle through an intelligent assessment of a plurality of operating parameters of the vehicle. As will be described, these parameters include the level of the vehicle battery (V_{BATT}), a current value of an engine speed (rpm) parameter 28₁ and a current value of a vehicle speed parameter 28₂. As shown, current values for the latter two parameters may be stored as OBD-II diagnostic and operating data parameters in a powertrain controller, such as the ECU 24₃, which may also store additional OBD-II parameters 28ₙ.

FIG. 2 is a schematic and block diagram of the power supply 10 of FIG. 1. The power supply 10 includes a controller 30, a switch 32, a plurality of protocol interface blocks 34₁, 34₂, 34₃, . . . , 34ₙ, a voltage regulator block 36, a conditioning circuit 38 and, optionally, one or more external indicators, such as a light-emitting diode (LED) 39. FIG. 2 also shows, in block form, the vehicle interface 16 and the output interface 18 shown in FIG. 1. The vehicle interface 16 is configured to allow communications by the controller 30 through the diagnostic port 20 to the vehicle network 22 by way of a plurality of communication lines 40 and is also configured to receive a power signal 42 (e.g., V_{BATT}) from the diagnostic port 20. The connector 16₃ (best shown in FIG. 1) is configured to be coupled to a corresponding connector 16₄ on the main board of the power supply 10 (i.e., the male-type DB-9 connector described above), in a constructed embodiment. Table 2 below provides a pin description for such a connector 16₄.

TABLE 2
Vehicle Interface Pin Description

| Pin Number | Pin Description |
|---|---|
| 1 | GND |
| 6 | J1850− |
| 2 | N.C. |
| 7 | J1850+ |
| 3 | CANH |
| 8 | ISO-L |
| 4 | ISO-K |
| 9 | V_{BATT} |
| 5 | CANL |

The controller 30 is configured, generally, to (i) determine an appropriate communication protocol to use for communicating with the vehicle network 22 (i.e., protocol determining logic block 44); and (ii) determine an operating state of the vehicle, namely, an ignition-on state or an ignition-off state (i.e., ignition-on state determining logic block 46). The controller 30 is further configured to measure the vehicle battery level V_{BATT} (i.e., battery level measuring block 48). Finally, the controller 30 is configured to assert an enable control signal 50 indicative of the vehicle operating state (i.e., ignition-on or ignition-off state) based on at least the measured battery level and the current values for the engine speed parameter 28₁ and the vehicle speed parameter 28₂. For this determination, the controller 30 is configured to make comparisons with predetermined threshold data 52 including a battery level threshold 52₁, an engine speed (rpm) threshold 52₂ and a vehicle speed (kph) threshold 52₃. When the measured battery level exceeds the battery level threshold and the current values for the engine speed and vehicle speed parameters exceed their respective thresholds, then the controller 30 will assert the enable control signal 50 indicative of the ignition-on state.

The controller 30 may comprise a conventional micro-controller having at least one microprocessor or other processing unit, associated and/or integrated memory devices such as read only memory (ROM) and random access memory (RAM), a timing clock or input therefore, input capability for monitoring input from external analog and digital devices or signals, such as an analog-to-digital input, and output capability for generating an output signal for controlling output devices, for example. The controller 30 may comprise conventional computing apparatus known to those of ordinary skill in the art, and that are commercially available, such as, for example only, the 16-bit MC9S12C-family of micro-controllers commercially available through Freescale Semiconductor, Austin, Tex., USA. It should be understood this example is not limiting in nature. It should be further understood that the controller 30 in certain embodiments will be configured to execute pre-programmed instructions stored in an associated memory to perform in accordance with the functions described herein. It is thus contemplated that the processes described herein will be programmed with the resulting software code being stored in the associated memory. Implementation of the invention, in software, in view of the foregoing enabling description, would require no more than routine application of programming skills by one of ordinary skill in the art. The controller 30, being of the type having both ROM, RAM, or a combination of non-volatile and volatile (modifiable) memory allows for the storage of the pre-programmed software and yet allow storage and processing of dynamically produced data and/or signals.

The switch 32 is coupled to receive the enable control signal 50 and is configured to selectively switch the power signal 42 (V_{BATT}) to the output interface 18 for use by an accessory based on whether the enable control signal 50 is asserted or not. When the enable signal 50 has been asserted by the controller 30, the switch 32 will respond to switch the power signal 42 (V_{BATT}) to the output interface 18, while when the enable signal 50 has been de-asserted by the controller 30, the switch 32 will respond conversely to disconnect the power signal 42 from the output interface 18. The switch 32 may comprise a conventional solid state switching device, particularly of the type (i) configured to handle all types of loads, such as resistive, inductive and capacitive loads, (ii) capable of being driven directly by a micro-controller such as the controller 30; and (iii) capable of switching power signals of the general 12 V DC type (i.e., as would be expected of V_{BATT}). It should be understood that any one of the foregoing features, while desirable, are not necessarily essential to the present invention. In a constructed embodiment, the switch 32 comprised a solid-state switch commercially available under the trade designation model BSP 762, Infineon Technologies, Milpitas, Calif., USA.

The protocol interface blocks 34₁, 34₂, 34₃, . . . , 34ₙ are disposed intermediate the vehicle interface 16 and the controller 30 in the power supply 10, and are respectively configured to provide protocol translation capability for communications between the controller 30, on the one hand, and the vehicle network 22 (via the diagnostic port 20) on the other hand. As known, different vehicle manufacturers operate on different vehicle networks/busses 22, and therefore present the need for individualized protocol translation capability (e.g., CAN, J1850, ISO 9141-2). The power supply 10 includes at least one of the protocol interface blocks, for example, where an embodiment of the power supply 10 is configured for a specific vehicle whose vehicle network 22 runs a particular known protocol. However, in preferred embodiment, the power supply 10 includes a plurality of protocol interface blocks to provide greater compatibility for use with differing vehicles whose vehicle networks run different protocols. While FIG. 2 shows the protocol interface blocks 34₁, 34₂, 34₃, . . . , 34ₙ having specifically-identified protocols, it should be understood that any combination of prevailing, in-use protocols may be implemented in any particular embodiment of the power supply 10. The protocol interface blocks 34₁, 34₂, 34₃, . . . , 34ₙ may each comprise conventional apparatus and approaches known in the art for implementing such protocols. For example only, the CAN protocol interface 34₁ may comprise a commercially available high-speed CAN transceiver designated by part number TJA1040 commercially available from NXP Semiconductors (f/k/a Philips Semiconductor), 1109 McKay Drive, San Jose, Calif., USA. It should be further understood that while each of the different protocol interfaces 34₁, 34₂, 34₃, . . . , 34ₙ are shown as a separate block, this invention does not require physically separate components/blocks (i.e., these protocol translation functions can be incorporated into a specific, single block or even IC). Table 3 below lists presently common protocols whose corresponding interface blocks may be used in the power supply 10. Of course, after-developed protocols are contemplated as within the spirit and scope of the invention.

TABLE 3
Exemplary Protocols
Protocols

SAE J1850 PWM (Pulse Width Modulation) (41.6 Kbaud)
SAE J1850 VPW (Variable Pulse Width) (10.4 Kbaud)
ISO 9141-2 (5 baud init, 10.4 Kbaud)
ISO 14230-4 KWP (Key Word Protocol) (5 baud init, 10.4 Kbaud)
ISO 14230-4 KWP (Key Word Protocol) (fast init, 10.4 Kbaud)
ISO 15765-4 CAN (Controller Area Network) (11 bit ID, 500 Kbaud)
ISO 15765-4 CAN (Controller Area Network) (29 bit ID, 500 Kbaud)
ISO 15765-4 CAN (Controller Area Network) (11 bit ID, 250 Kbaud)
ISO 15765-4 CAN (Controller Area Network) (29 bit ID, 250 Kbaud)
SAE J1939 CAN (Controller Area Network) (29 bit ID, 250 Kbaud)

The voltage regulator 36 is configured to provide a regulated, known voltage output for use by the internal components (e.g., the controller 30) of the power supply 10. This power output should be distinguished from the power output provided by the power supply 10 on the output interface, which is un-regulated V_{BATT} (albeit ignition-switch emulated, as described herein). The voltage regulator 36 may comprise conventional components known in the art for such purpose, for example only, an LM2931 series low dropout voltage regulator commercially available from National Semiconductor, 2900 Semiconductor Drive, Santa Clara, Calif., USA.

The conditioning circuit 38 is provided to appropriately condition, if needed, the raw vehicle battery voltage (V_{BATT})/power signal 42 so that it can be digitally sampled by the controller 30. In this regard, in one embodiment, the circuit 38 comprises a simple voltage divider network configured to scale (i.e., reduce) the vehicle battery voltage so that it is within a voltage range that the A/D converter of the controller 30 can accept.

The LED 39 is configured to provide an external indication to a user that the power supply 10 is in communication with the vehicle network 22 via the diagnostics (OBD-II) port 20, and may further be used to indicate proper operation of the power supply to the user. Error states may also be communicated by flashing the LED with various patterns.

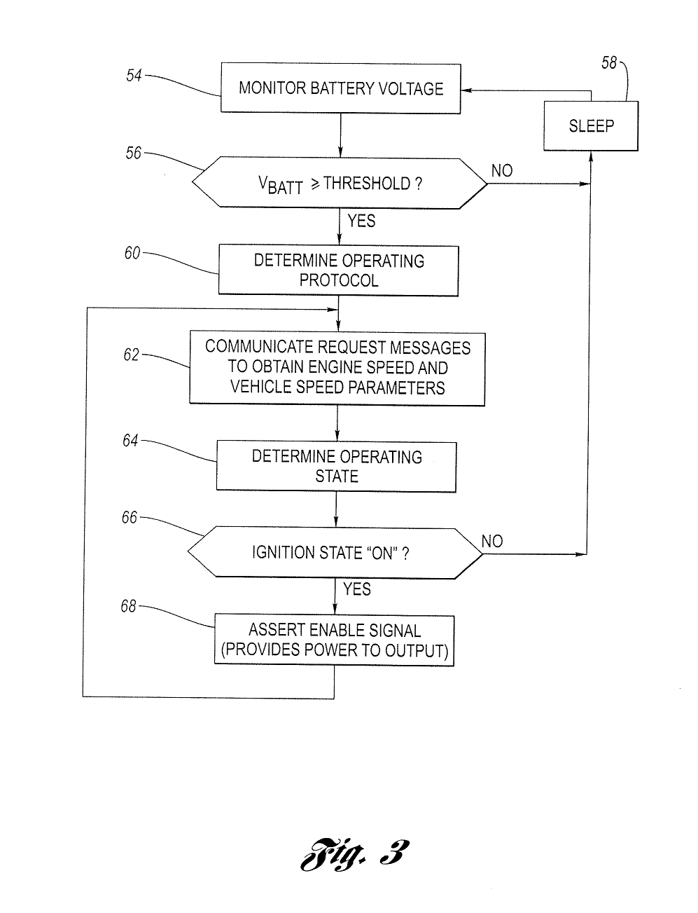

FIG. 3 is flowchart diagram showing a method of operating a power supply 10 in accordance with the invention. The invention emulates the functionality of switched-ignition power in a vehicle. The method begins in step 54.

In step 54, the controller 30 is configured to monitor the level of the power signal 42 (V_{BATT}) that appears on the vehicle diagnostics (OBD-II) port 20. Note, this power signal 42 is un-switched vehicle battery. To perform this function, the controller 30 is configured to periodically sample (A/D) the conditioned power signal 42 as produced by the circuit 38. The method proceeds to step 56.

In step 56, the controller 30 is configured to compare the monitored power signal (V_{BATT}) against the predetermined battery level threshold 52₁. If the monitored power signal 42 (V_{BATT}) is lower than the threshold 52₁, then the method branches to step 58 (“SLEEP”). Otherwise, if the monitored power signal 42 (V_{BATT}) is equal to or exceeds the threshold 52₁, then the method branches to step 60. This decision-making sequence reflects the logic that if the vehicle battery level is too low, then the power supply 10 will not energize the output interface 18, thereby preventing the accessory 14 from being powered and perhaps preventing the accessory from draining an already weak battery. In a constructed embodiment, the following battery levels were equated with a respective, corresponding percentage levels of battery charge: 12.7 volts=100%, 12.5 volts=75%, 12.2 volts=50%, 12.1 volts=25%, 11.9 volts=0% battery. In this embodiment, the battery charge level must exceed 90% (i.e., the threshold 52) for the logic to proceed to step 60. Otherwise, the power supply 10 will enter a sleep mode (block 58), but continue to monitor the vehicle battery for changes. It should also be understood that to the extent that the power signal 42 (V_{BATT}) has been scaled down or otherwise altered in a known fashion by the circuit 38, that the selected battery level threshold 52₁ would likewise be scaled down or altered so that the controller 30 is able to make an accurate assessment of the actual power signal 42 (V_{BATT}) available on the OBD-II port 20.

In step 60, the controller 30 is configured to determine the operating protocol of the vehicle network 22 (e.g., CAN, J1850, ISO 9141-2). It may do this through the detection of traffic on predefined pins, through the use of suitable query/response techniques and in other ways known in the art. Once the operating protocol has been determined, this identification is stored and is used for any further communications during the current power-on cycle. The method then proceeds to step 62. In one embodiment, the process of determining the protocol involves trial and error. First, the last known protocol (stored value) is tried. If this fails, then the remaining protocols are tried in order until the vehicle begins communicating, which is determined by requesting a parameter such as the vehicle speed (VS) and waiting for a response. If no protocol is found, then an error is stored and indicated to the user (e.g., via LED 39).

In step 62, the controller 30 is configured to initiate communications with the vehicle network 22 through the vehicle diagnostics (OBD-II) port 20, all in accordance with the previously identified operating protocol (e.g., CAN, J1850, ISO 9141-2). In particular, the controller 30 is configured to transmit queries (e.g., in the form of OBD-II messages) for the current values of the engine speed parameter and the vehicle speed parameter. The controller 30 is further configured to store the responses to these queries, when received. The method then proceeds to step 64.

In step 64, the controller 30 is configured to determine the operating state of the vehicle (i.e., an ignition-on state or an ignition-off state). The controller 30 first compares the current value of the engine speed parameter to the predetermined engine speed threshold 52₂. To satisfy this test, the current value of the engine speed must be equal to or exceed the threshold 52₂. However, there are sometimes dropouts in the value of the engine speed parameter (i.e., the OBD-II query for the engine speed returns a zero value). As a safeguard against an erroneous determination, the controller 30 performs a second check in such a situation. The controller 30 compares the current value of the vehicle speed parameter to the predetermined vehicle speed threshold 52₃. To satisfy this test, the current value of the vehicle speed must be equal to or exceed the threshold 52₃. When neither threshold 52₂ and 52₃ is satisfied, the controller 30 determines that the vehicle operating state is an ignition-off state. However, when the thresholds are satisfied, then the controller 30 determines that the operating state is an ignition-on state. The method then proceeds to step 66.

It should be understood that the Vehicle Speed and Engine Speed parameters are always requested by the controller 30 because of the possibility of data drop outs. Starting in a keyed-off (ignition off) state: If the controller 30 is able to receive back data from the ECU 24₃ (regardless of the value), then the vehicle is assumed to be communicating and keyed-on (ignition on). In some configurations, the controller 30 is configured to wait for the engine speed RPM>400 before applying output power (i.e., asserting the enable control signal). This logic ensures that the vehicle is actually running. Once the controller 30 determines that the vehicle is keyed-on, the controller 30 is configured to begin looking for indications that the vehicle is keyed-off. The logic for detecting this condition is not obvious, as data may still be communicated over the network even with the key-off. The controller 30 is configured to look for the engine speed (RPM) to be zero and the vehicle speed (VS) to be zero. Once those conditions are met, the vehicle is determined to be in a key-off (or ignition off state).

In step 66, the controller 30 determines whether the vehicle operating state is in an ignition-on state. If the answer is “NO,” then the method branches to step 58 (“SLEEP”). Otherwise, when the answer is “YES” (i.e., the operating state is an ignition-on state), then the method branches to step 68. In this regard, the controller 30 may be configured to periodically check (e.g., two times per second) the engine speed and vehicle speed parameters, as described above. When an ignition-off is detected based on these conditions, the power supply 10 enters the sleep state (“58”).

In step 68, the controller 68 asserts the enable control signal 50. In one embodiment, the enable control signal 50 is provided to the output interface 18, where it may be used as an external trigger for activating an external, trigger-operated power supply. In a preferred embodiment, however, the assertion of the enable control signal 50 is responded to by the switch 32, which in turn provides the vehicle power signal 42 (V_{BATT}) to the output interface 18 for use by an attached accessory. It should be understood that “to assert” the enable control signal may involve different electrical sequences depending upon whether the switch 32 is an active high, active low, edge-triggered, etc. as known by those of ordinary skill in the art. In a still further embodiment, the power supply 10 includes both an external trigger as well as a direct ignition-switch emulated power output. The method then proceeds to step 58 (“SLEEP”).

While particular embodiments of the invention have been shown and described, numerous variations and alternate embodiments will occur to those skilled in the art. For example, the output of the power supply 10 can be V_{BATT}, a switched signal, or a conditioned voltage such as 5 VDC. In many cases it is preferable to output a conditioned voltage so that a separate power supply is not needed to connect an accessory. Other connections may be used to obtain key-switched ignition power, such as a standard barrel and pin power supply connection. Multiple connection types or points may be used to obtain all of the various outputs (V_{BATT}, switched signal, 5 VDC, 3.3 VDC, etc.). Accordingly, it is intended that the invention be limited only in terms of the appended claims.

1. A power supply, comprising:
a vehicle interface configured for connection to a vehicle diagnostic port, said port configured to provide access to vehicle network to which at least one vehicle device is connected; and
a controller configured to communicate through said diagnostic port to obtain an engine speed parameter and a vehicle speed parameter, said controller being further configured to generate an enable control signal indicative of a vehicle ignition-on state based on at least said engine speed and vehicle speed parameters.

2. The power supply of claim 1 wherein said vehicle interface is further configured to receive a power signal from said diagnostic port, said controller being configured to generate said enable control signal further as a function of a level of said power signal, said power supply further including a switch configured to selectively switch said power signal to an output interface in accordance with said enable signal.

3. The power supply of claim 1 wherein said controller is configured to generate said enable signal further as a function of a level of said power signal, said power supply further comprising an output interface coupled to received said enable control signal.

4. The power supply of claim 2 wherein said vehicle interface comprises an on-board diagnostics (OBD-II) diagnostic connector.

5. The power supply of claim 4 wherein said OBD-II diagnostic connector is configured in accordance with a Society of Automotive Engineers (SAE) J1962 standard.

6. The power supply of claim 2 wherein said output interface comprises an output connector.

7. The power supply of claim 6 wherein said output connector comprises an RJ-11 jack.

8. The power supply of claim 2 further comprising a protocol interface intermediate said controller and said vehicle interface, said protocol interface being one selected from the group comprising (i) a controller area network (CAN) protocol interface, (ii) a society of automotive engineers (SAE) J1850 standard protocol interface; (iii) an international standards organization (ISO) 9141-2 standard protocol interface; (iv) an ISO 14230 standard protocol interface; and (v) an SAE J1939 standard protocol interface.

9. A method of operating a power supply having a vehicle interface and an output interface, said vehicle interface being configured for connection to a vehicle diagnostic port wherein the port provides access to a vehicle network to which at least one vehicle device is connected, said method comprising the steps of:
(A) monitoring a level of a power signal on said port;
(B) determining an operating protocol of the vehicle network;
(C) communicating messages in accordance with said determined operating protocol through the diagnostic port to obtain current values for engine speed and vehicle speed parameters; and
(D) asserting an enable control signal indicative of an ignition-on state of the vehicle based on the current values for engine speed and vehicle speed and when the power signal level exceeds a predetermined minimum threshold.

10. The method of claim 9 further including the step of:
switching the power signal onto the output interface when the enable control signal has been asserted.

11. The method of claim 9 further including the step of:
providing the enable control signal to the output interface to thereby enable control of an external power source.

12. The method of claim 9 wherein said step of asserting the enable control signal includes the sub-step of:
determining whether the current values of the engine speed and vehicle speed parameters are equal to or exceed respective first and second threshold values.

13. The method of claim 12 further including the step of:
de-asserting the enable control signal when the current values for the engine speed and vehicle speed parameters are less than the respective first and second threshold values.
